(19) United States
(12) Patent Application Publication
(10) Pub. No.: US 2013/0000563 A1
(43) Pub. Date: Jan. 3, 2013

(54) Animal toy and related method of fabrication

(76) Inventor: Xu Shen, Shang Hai (CN)

(21) Appl. No.: 13/273,101

(22) Filed: Oct. 13, 2011

(30) Foreign Application Priority Data
Jun. 29, 2011 (CN) 201110177989.X

(51) Int. Cl. A01K 29/00; B32B 5/20

(52) U.S. Cl. 119/707; 156/77

(57) ABSTRACT

The purpose of the present invention is to provide an animal toy and its manufacturing process. The animal is not easily destroyed when bitten by an animal, and its light weight reduces the risk of harm to an animal when the toy is thrown.

### CROSS-REFERENCE TO RELATED APPLICATIONS

This application claims priority benefit of application number 201110177989.X filed Jun. 29, 2011 in the State Intellectual Property Office of the Peoples' Republic of China (SIPO).

### FIELD OF THE INVENTION

This invention relates to toys and their manufacturing processes, specifically toys for pets and their manufacturing process.

### BACKGROUND OF THE INVENTION

U.S. Pat. No. 6,415,740 describes a method and apparatus for reducing risk that a thrown toy will injure an animal. The patent literature is intended to reduce the risk of harm to an animal trying to catch the toy which has been thrown. The description of the method comprises the steps of:
Manufacturing two symmetrical sheets of rubber using die-cast machining equipment
Bonding the two sheets to form a hollow cavity
Covering the surface of the cavity with two or more pieces fabric
Embedding rubber tape into the joint between the sheets to prevent the fabric from easily tearing
Die-casting the rubber cavity, fabric and rubber tape assembly to produce the toy

US 2006/0102098 describes an animal toy manufacturing method, which comprises making a solid core of rubber or latex, then covering the core with a layer of fabric (felt fabric similar to a tennis ball, fake fur, or chenille), with the option of using two or more kinds of fabric on the solid core. The purpose of the application is to solve the problem that in general, rubber toys are easily broken when bitten by dogs.

### SUMMARY OF THE INVENTION

The present invention is a novel pet play toy and its related manufacturing processes. The pet play toy is not easily destroyed by pet biting, and it would not be harmful to the pets when the toy hits them. The pet toy comprises a first sheet layer, a second sheet layer, a first fabric layer, and a second fabric layer. The first sheet layer stacks together with the first fabric layer. The second sheet layer stacks together with the second fabric layer. Each of the first and second fabric layers are on the outside surface with respect to the first and second sheet layers. The edges of the first sheet layer, the second sheet layer, the first fabric layer and the second fabric layer are fused through thermal pressing. The thermal pressing also creates a central cavity. The central cavity contains the foam layer. Therefore, the present invention is a thermally fused assembly containing three layers of material, with no air pockets.

### BRIEF DESCRIPTION OF THE DRAWINGS

The features of the invention believed to be novel are set forth in the appended claims. The invention, however, together with further objects and advantages thereof, may best be understood by reference to the following description taken in conjunction with the accompanying drawing(s) summarized below.

FIG. 1 is a view of the primary embodiment of the present invention.

FIG. 2 is the cross-sectional view of the primary embodiment of the present invention.

FIG. 3 is an exploded view of the five layers of material and the die-cast mold used to fabricate the invention.

FIG. 4 illustrates the assembled mold of the die-cast manufacturing process.

FIG. 5 is the final product from the mold after die-casting.

FIG. 6 is a second embodiment of the present invention.

FIG. 7 is a third embodiment of the present invention.

### DETAILED DESCRIPTION

The purpose of the present invention is to provide an animal toy and its manufacturing process. The animal is not easily destroyed when bitten by an animal, and its light weight reduces the risk of harm to an animal when the toy is thrown.

In order for the animal toy to achieve the above purpose, it comprises a first sheet layer, a second sheet layer, a first fabric layer, and a second fabric layer. The first sheet layer stacks together with the first fabric layer. The second sheet layer stacks together with the second fabric layer. Each of the first and second fabric layers are on the outside surface with respect to the first and second sheet layers. The edges of the first sheet layer, the second sheet layer, the first fabric layer and the second fabric layer are combined through thermal pressing with the foam layer in the center. The thermal pressing creates a central cavity, which contains the foam layer.

More specifically, the preferred material for the first and second sheet layers is rubber.

More specifically, the preferred material for the first and second fabric layers is felt fabric (similar to a tennis ball), artificial wool, or chenille.

More specifically, the invention reduces the risk of harm to the animal because the weight of the toy is significantly reduced by using a foam layer in the middle, as opposed to a solid core of the same material as the sheet layers. In addition, the toy is not easily broken since the central cavity is filled and not hollow, based on the materials and the manufacturing process.

The specifics of the manufacturing process of the above described animal toy are:
Cut out the first sheet layer, the second sheet layer, the first fabric layer, the second fabric layer and the foam layer.
The foam layer is the center of the assembly, superimpose the first sheet layer and the first layer of fabric on one side of foam layer, superimpose the second of sheet layer and the second layer of fabric on the other side of foam layer.
Put the assembly of the first fabric layer, the first sheet layer, the foam layer, the second sheet layer, the second fabric layer into the die cavity of the mold. The shape of the die cavity mold is the same as the exterior shape of the resultant toy.
Push the first layer of fabric and the first sheet layer into the top half of the mold in that order.
Push the second layer of fabric and the second sheet layer into the bottom half of the mold in that order.
The die-casting machine then heats the mold, bonds the edges of the first sheet layer and the first fabric layer together, the second sheet layer and the second fabric layer together, with the foam layer in the central cavity. This process can also be referred to as thermal pressing. The foam layer, in between the two sheet layers, comprises a material capable of permanently expanding when heated, and so swells due to the heat. The foam layer continually swells until the die cavity is full. Die-casting the four layers of material, fills the center cavity with the foam material.

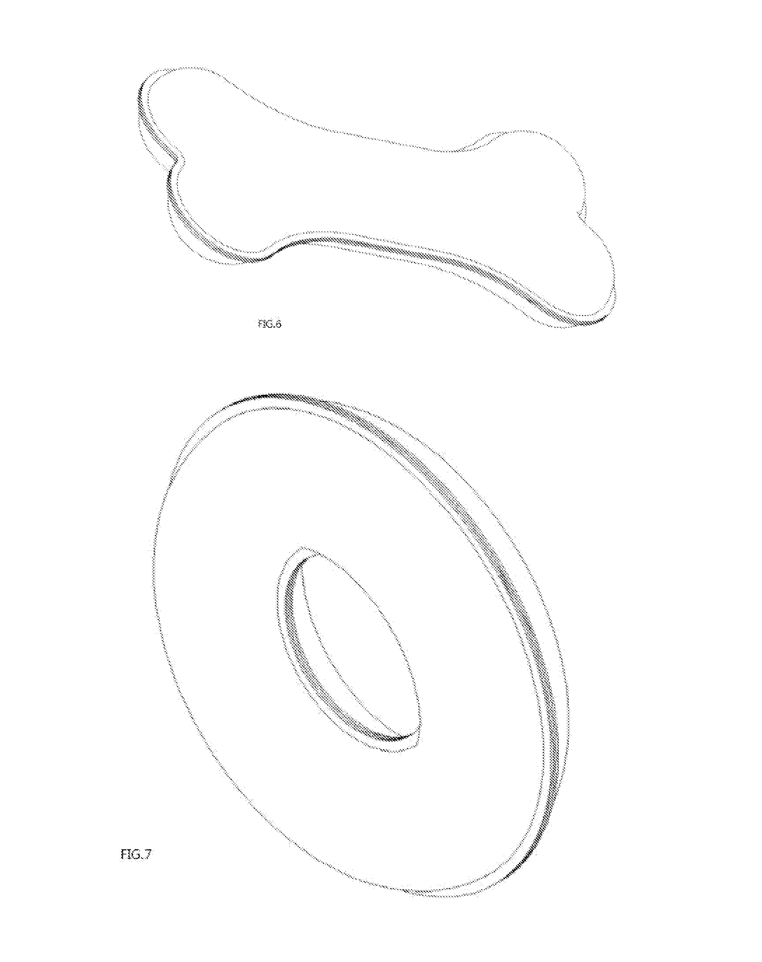

Referring to FIG. 1, the preferred embodiment of the present invention is a throwable animal toy shaped like a boomerang. FIGS. 6 and 7 respectively, show alternative, exemplary, not limiting, embodiments of the present invention in which the animal toy is shaped as a bone and as a ring. Regardless of the shape, which is imparted by the shape of the mold used, the novel and nonobvious manufacturing process for the toy is the same, as are the novel and non-obvious characteristics of the toy which make the toy safe for animals. Following the manufacturing process of the present invention, the toys can be made in any shape, and are not limited to the aforementioned three shapes. Regardless of the shape, all of the toys have the same internal layered structure.

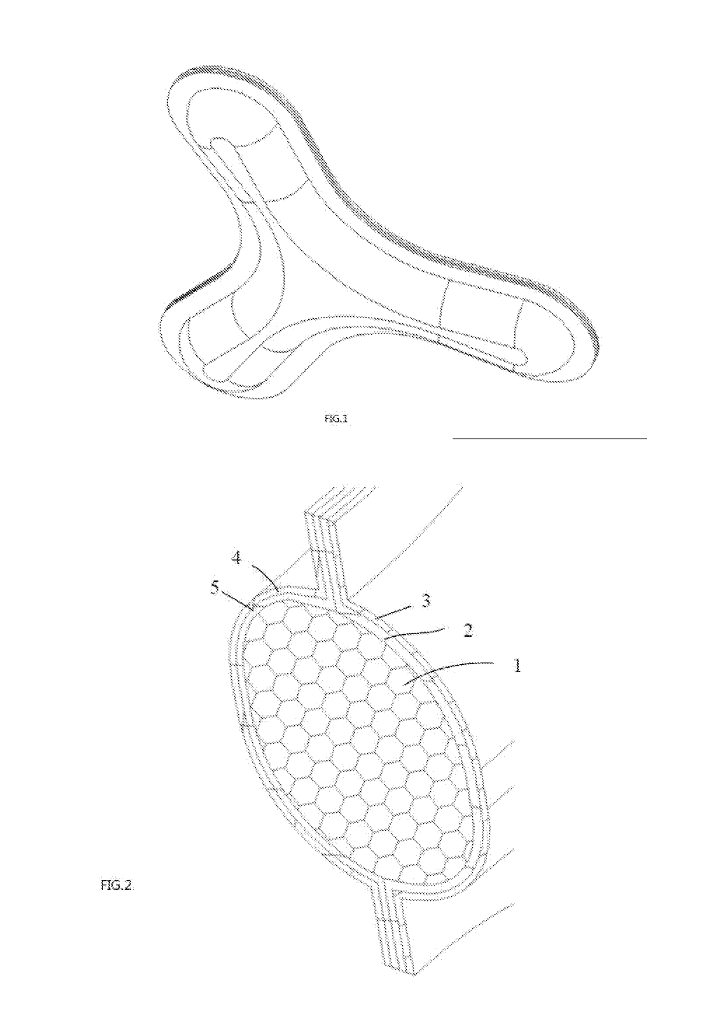

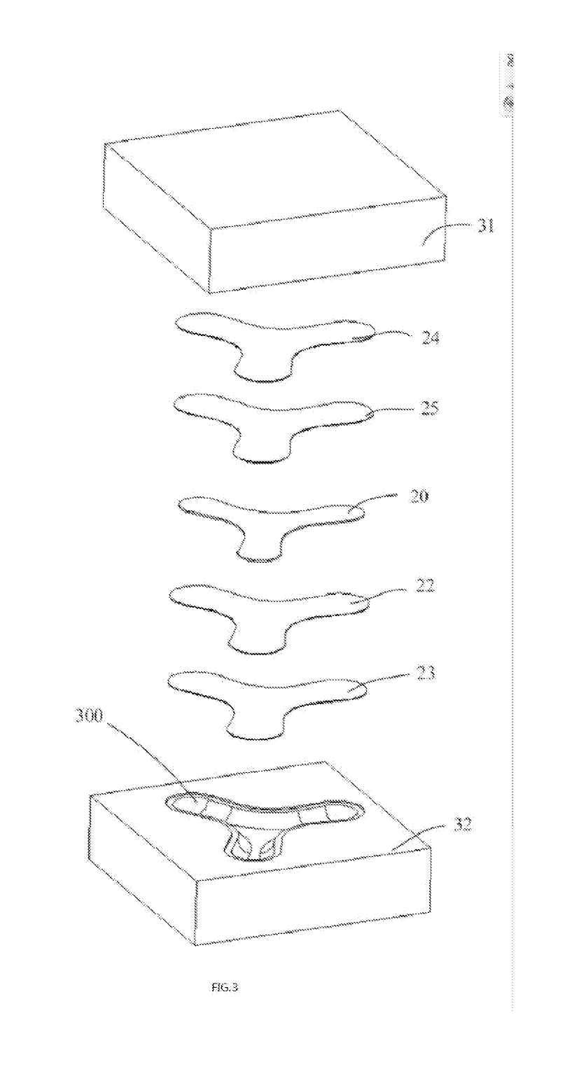

Referring to FIG. 2, the animal toy comprises five (5) layers, as shown in the material cross section. Symmetrically placed are the first sheet layer 2 and the second sheet layer 5. Also symmetrically placed are the first layer of fabric 3 and the second layer of fabric 4. In the manufacturing process, the first sheet layer 2 and the first layer of fabric 3 are stacked together. Similarly the second sheet layer 5 and the second layer of fabric 4 are also stacked together. The first and second fabric layers 3 and 4 are on the outside of the first and second sheet layers 2 and 5. The four layers of material, including the first and second fabric layer 3 and 4 and the first and second sheet layers are assembled in a die-cast molding process with the center cavity filled with foam material 1. Die-casting the four layers of material, fills the center cavity with the foam material. The toy is so light because the center layer is foam material 1, so when throwing the toy to the pet, it will not harm the pet. In addition, the toy is not easily broken, because foam material 1 fills the hollow center cavity between the first and second sheet layers 2 and 5. First and second fabric layers 3 and 4 are made from material such as felt fabric similar to that of a tennis ball, artificial wool, or chenille. As noted above, first and second sheet layers 2 and 5 comprise rubber or equivalent material.

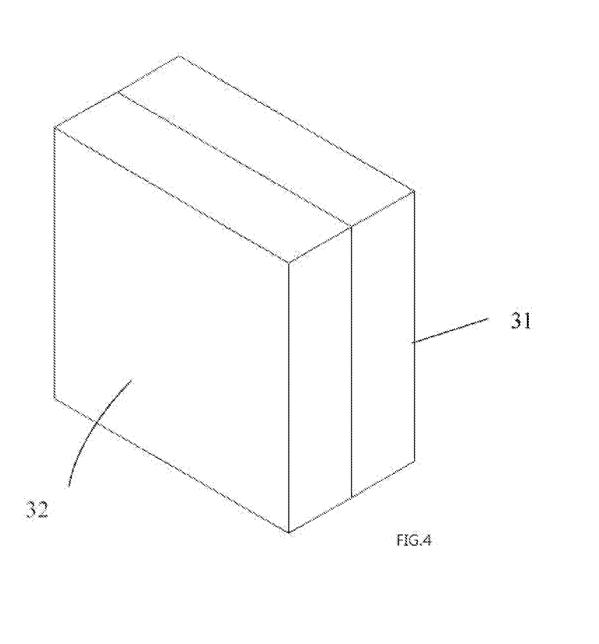

Referring to FIG. 3, the first sheet layer 22, the second sheet layer 25, the first fabric layer 23, the second fabric layer 24, and the foam layer 20 are cut to the same shape. To assemble, the five layers of material in mold cavity 300 are neatly aligned, with the foam material layer 20 in the center, the first and second sheet layers 22 and 25 placed on either side of the foam layer 20, essentially sandwiching it, then the first and second fabric layers 23 and 24 placed on the outside of the first and second sheet layers 22 and 25. The top half of the mold 31 and the bottom half mold 32 are assembled to form the mold cavity 300.

Referring to FIG. 4, the top half of the mold 31 and the bottom half of the mold 32 are assembled in the manufacturing process. The manufacturing process in the die-cast mold, is a thermal process. Once the mold is assembled, heat is applied for a given period of time to seal the edges of the fabric and sheet layers around the foam layer. The heat application also stimulates expansion of the foam layer to completely fill the central cavity. The processing of the die-casting (time and temperature) can be changed according the requirements of the materials being assembled and the mold can be changed according different shape of the toys desired, the shapes being non-limiting as mentioned earlier.

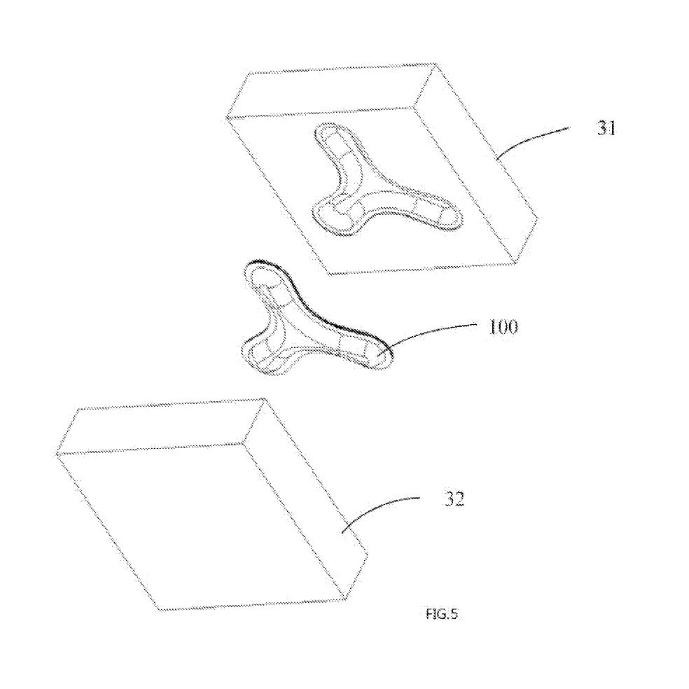

Referring to FIG. 5, after die-casting manufacturing process is complete, open the top half of the mold 31 and the bottom half of the mold 32, to produce the final animal toy product 100. Any excess material beyond the desired shape of the product 100 can be cut away.

The knowledge possessed by someone of ordinary skill in the art at the time of this disclosure is understood to be part and parcel of this disclosure and is implicitly incorporated by reference herein, even if in the interest of economy express statements about the specific knowledge understood to be possessed by someone of ordinary skill are omitted from this disclosure. While reference may be made in this disclosure to the invention comprising a combination of a plurality of elements, it is also understood that this invention is regarded to comprise combinations which omit or exclude one or more of such elements, even if this omission or exclusion of an element or elements is not expressly stated herein, unless it is expressly stated herein that an element is essential to applicant's combination and cannot be omitted. It is further understood that the related prior art may include elements from which this invention may be distinguished by negative claim limitations, even without any express statement of such negative limitations herein. It is to be understood, between the positive statements of applicant's invention expressly stated herein, and the prior art and knowledge of the prior art by those of ordinary skill which is incorporated herein even if not expressly reproduced here for reasons of economy, that any and all such negative claim limitations supported by the prior art are also considered to be within the scope of this disclosure and its associated claims, even absent any express statement herein about any particular negative claim limitations.

Finally, while only certain preferred features of the invention have been illustrated and described, many modifications, changes and substitutions will occur to those skilled in the art. It is, therefore, to be understood that the appended claims are intended to cover all such modifications and changes as fall within the true spirit of the invention.

We claim:

1. An animal toy comprising:
a first sheet layer;
a second sheet layer;
a first fabric layer;
a second fabric layer;
a foam layer between said first and second sheet layers, comprising a material capable of permanently expanding when heated;
said first sheet layer stacked together with said first fabric layer, and said second sheet layer stacked together with said second fabric layer;
each of said first and second fabric layers on an outside of the toy with respect to said first and second sheet layers;
edges of said first sheet layer, said second sheet layer, said first fabric layer and said second fabric layer permanently attached together in combination as a consequence of thermal pressing; and
said foam layer configured to substantially fill a cavity between said sheet layers as a consequence of said thermal pressing.

2. The apparatus of claim 1, said first and second sheet layers comprising rubber or equivalent material.

3. The apparatus of claim 1, said fabric layers comprising tennis material, artificial wool or chenille.

4. A method of fabricating an animal toy comprising:
cutting out a first sheet layer;
cutting out a second sheet layer;
cutting out a first fabric layer;
cutting out a second fabric layer;
cutting out a foam layer comprising a material capable of permanently expanding when heated; and
centering on a first side of said foam layer, a stack of said first sheet layer, then said first fabric layer; and
centering on a second side of said foam layer, a stack of said second sheet layer, then said second fabric layer; and
placing the foregoing assembly of said first sheet layer, said first fabric layer, said foam layer, said second sheet layer, and said second fabric layer into a mold cavity, said mold cavity having a desired shape of said animal toy;
pressing upper and lower halves of the mold upon said first sheet layer, said first fabric layer, said foam layer, said second sheet layer, and said second fabric layer; and
heating the mold such that said first sheet layer, said first fabric layer, said second sheet layer, said second fabric layer, including edges of each said layer, are all pressed together into a permanent attachment; and such that said foam layer expands by virtue of said heating to create and substantially fill a cavity between said sheet layers.

5. The method of claim 4, said sheet layers comprising rubber or equivalent material.

6. The method of claim 4, said fabric layers comprising felt material similar to a tennis ball, artificial wool or chenille.

7. An animal toy product-by-process, said process comprising:
cutting out a first sheet layer;
cutting out a second sheet layer;
cutting out a first fabric layer;
cutting out a second fabric layer;
cutting out a foam layer comprising a material capable of permanently expanding when heated; and
centering on a first side of said foam layer, a stack of said first sheet layer, then said first fabric layer; and
centering on a second side of said foam layer, a stack of said second sheet layer, then said second fabric layer; and
placing the foregoing assembly of said first sheet layer, said first fabric layer, said foam layer, said second sheet layer, and said second fabric layer into a mold cavity, said mold cavity having a desired shape of said animal toy;
pressing upper and lower halves of the mold upon said first sheet layer, said first fabric layer, said foam layer, said second sheet layer, and said second fabric layer; and
heating the mold such that said first sheet layer, said first fabric layer, said second sheet layer, said second fabric layer, including edges of each said layer, are all pressed together into a permanent attachment; and such that said foam layer expands by virtue of said heating to create and substantially fill a cavity between said sheet layers.

8. The product-by-process of claim 7, said sheet layers comprising rubber or equivalent material.

9. The product-by-process of claim 7, said fabric layers comprising felt material similar to a tennis ball, artificial wool or chenille.
